(19) United States
(12) Patent Application Publication
(10) Pub. No.: US 2011/0035179 A1
(43) Pub. Date: Feb. 10, 2011

(54) SYSTEM AND METHOD FOR TESTING ELECTRONIC DEVICE

(75) Inventors: SHAO-PU TAO, Shenzhen City (CN); XUE-MING LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRCISION INDUSTRY CO., LTD., Tu-Cheng (TW)

(21) Appl. No.: 12/624,927

(22) Filed: Nov. 24, 2009

(30) Foreign Application Priority Data
Aug. 10, 2009 (CN) 200910305448.3

(51) Int. Cl. G01M 19/00; G06F 17/30

(52) U.S. Cl. 702/122; 707/600; 707/E17.01

(57) ABSTRACT

A testing system includes a server device and at least one testing station communicating with the server device. The server device includes a storage unit, a configuration module, and an executing module. The storage unit stores a testing task function database therein. The testing task function database includes a plurality of testing task functions, which are capable of controlling the at least one testing station. The configuration module is capable of setting a testing item corresponding to the at least one testing station and identification numbers of testing tasks to the testing item. Each identification number of the testing tasks corresponds to one of the testing task functions. The executing module is capable of reading the testing task functions from the testing task function database according to the identification numbers of the testing tasks and starting the testing task functions to control the least one testing station to test the electronic devices.

### BACKGROUND

1. Technical Field

The present disclosure relates to systems and methods, and particularly to a device and a method for testing stations to test electronic devices.

2. Description of Related Art

Electronic devices, such as desktop computers, notebook computers, digital photo frames, mobile telephones and so on, usually require a test before being placed on the market. Many parts of the electronic devices, such as a keyboard, a light-emitting diode, a power supply and so on should be tested. Therefore, there are so many testing programs, it is very difficult to manage.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a testing system and a plurality of electronic device to be tested in accordance with an embodiment.

FIG. 2 is a flow chart of a process for testing the electronic device in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

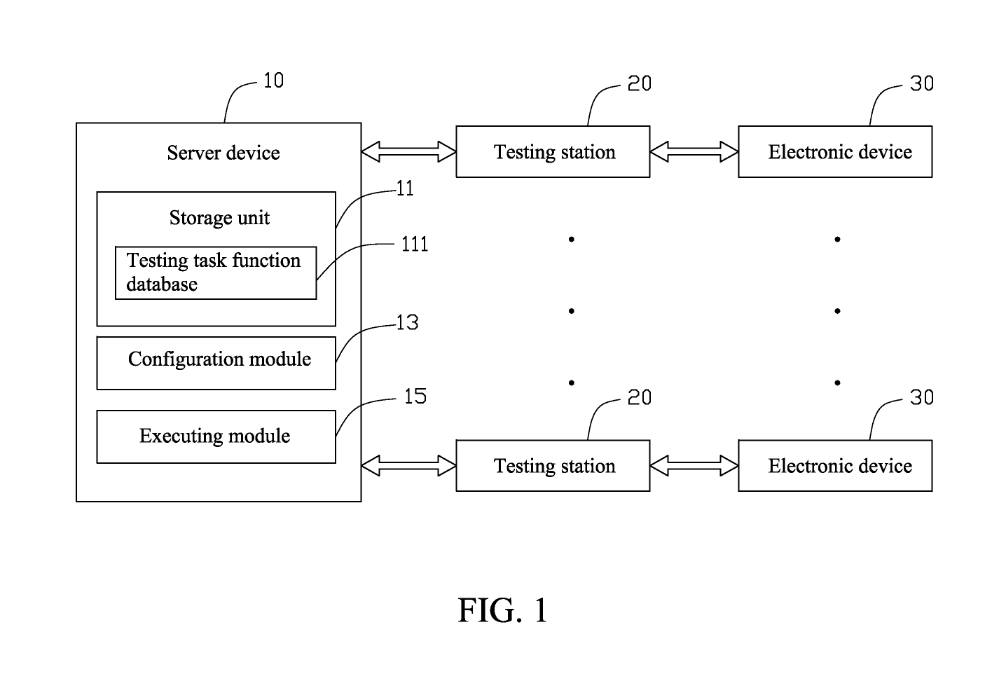

Referring to FIG. 1, a testing system in accordance with an embodiment includes a server device 10 and a plurality of stations 20 communicating with the server device 10. The server device 10 may be a computer, or a server, etc. The testing stations 20 are capable of testing electronic devices 30. The testing station 20 may be, for example, a keyboard testing device, a mouse testing device, or a Universal Serial Bus (USB) testing device, etc. The electronic device 30 may be, for example, a desktop computer, a notebook computer, a digital photo frame, a personal digital assistant, or a mobile telephone, etc.

The server device 10 includes a storage unit 11, a configuration module 13, and an executing module 15.

The storage unit 11 stores a testing task function database 111. The testing task function database 111 includes a plurality of testing task functions, according to which the testing stations 20 test the electronic devices 30. Each of the testing tasks is designated to one testing task function of the testing task function database 111. In one embodiment, the testing task may be, for example, a keyboard testing, a mouse testing, a USB testing, etc.

The configuration module 13 is capable of setting testing data, which is saved in the storage unit 11. In one embodiment, the testing data is saved as a file, and the file may be INI file. The testing data includes testing items, property of the testing stations 20, and property of the electronic devices 30. One testing item is assigned to one testing station 20. The property of the testing stations may be, for example, sequence numbers, or names, etc. The property of the electronic devices 30 may be names, etc., for example.

The configuration module 13 is further capable of setting identification numbers of testing tasks in the testing items and determining testing sequence of the testing stations 20 to test the electronic device 30. In addition, the configuration module 13 is capable of setting formats of the testing report.

The executing module 15 is capable of reading testing task functions according to the identification numbers of testing tasks in the testing items and starting the testing task functions to control the testing stations 20 to test the electronic devices 30. In addition, the executing module 15 is further capable of exporting a testing report.

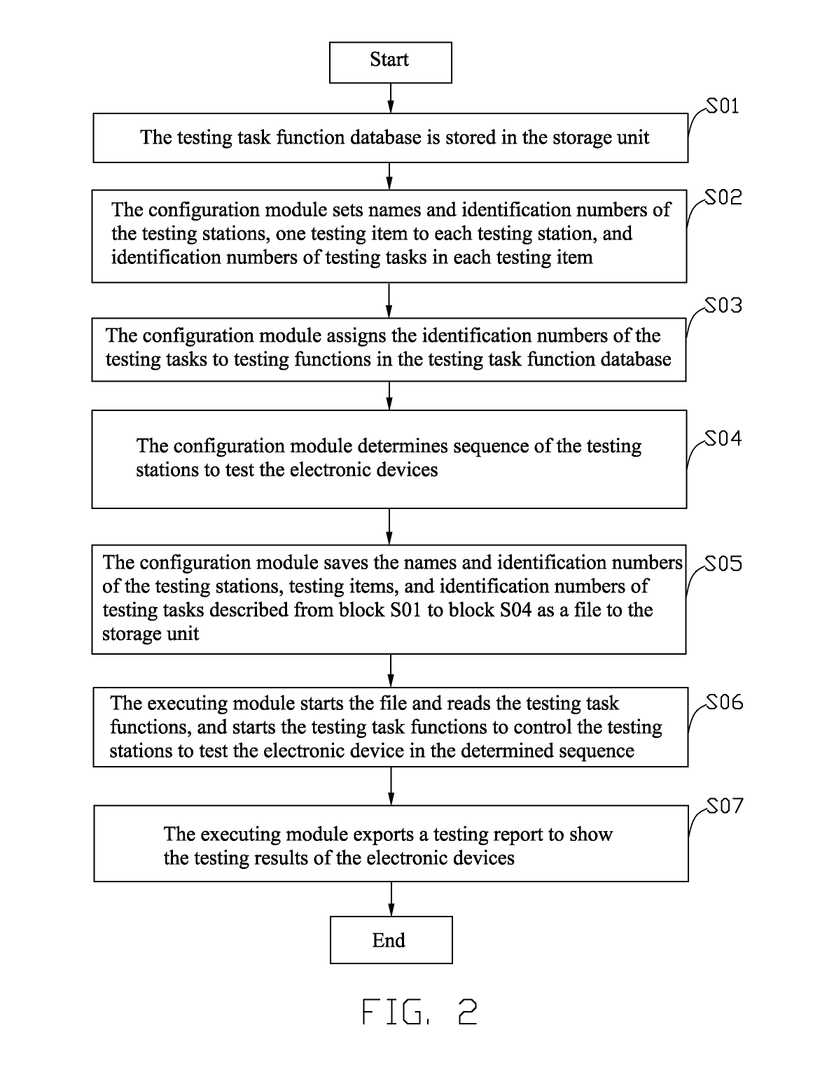

FIG. 2 illustrates a process to test the electronic devices 30. The process is described as following.

In block S01, the testing task function database 111 is stored in the storage unit 11.

In block S02, the configuration module 13 sets names and identification numbers of the testing stations 20 (one testing item to each testing stations 20) and identification numbers of testing tasks in each testing item. For example, the configuration module 13 sets the names B1, B2 and the identification numbers 1, 2 of the testing stations 20. The identification number 1 is corresponding to the B1 testing station, and the identification number 2 is corresponding to the B2 testing stations. The configuration module 13 sets one testing item to the B1 testing stations and the B2 testing stations. The testing item to the B1 testing stations includes testing task identification numbers 1 and 2, and the testing item to the B2 testing station includes a testing task identification number 3.

In block S03, the configuration module 13 assigns the identification numbers of the testing tasks to testing functions in the testing task function database 111. For example, the testing task identification number 1 is assigned to the keyboard test function, the testing task identification number 2 is assigned to the mouse testing function, and the testing task identification number 3 is assigned to a keyboard testing function.

In block S04, the configuration module 13 determines sequence of the testing stations 15 to test the electronic devices 30. For example, the B1 testing station tests the electronic device 30 firstly, and the B2 testing station tests the electronic device 30 secondly. And the B1 testing station, the keyboard test is done firstly, and the mouse test is done secondly.

In block S05, the configuration module 13 saves the names and identification numbers of the testing stations 20, testing items, and identification numbers of testing tasks described from block S01 to block S04 as a file to the storage unit 11.

In block S06, the executing module 15 starts the file and reads the testing task functions from the testing task function database 111 according to each identification number of the testing tasks, and starts the testing task functions to control the testing stations 20 to test the electronic device 30 in the determined sequence. For example, in the B1 testing station, the testing task identification number 1 reads the keyboard testing function from the testing task function database 111 to test the keyboard of the electronic device 30, then the testing task identification number 2 reads the mouse testing function from the testing task function database 111 to test the mouse of the electronic device 30. Then in B2 testing station, the testing task identification number 3 reads the USB testing function from the testing task function database 111 to test the USB port of the electronic device 30.

In block S07, the executing module 15 exports a testing report to show the testing results of the electronic devices 30.

In one embodiment, in block S02, the configuration module 13 further modifies the names and identification numbers of the testing stations and the testing items, if needed.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A testing system comprising:
a server device and at least one testing station communicating with the server device, the server device comprising:
a storage unit with a testing task function database stored therein, the testing task function database comprises of a plurality of testing task functions, which are capable of controlling the at least one testing station;
a configuration module capable of setting a testing item corresponding to the at least one testing station and identification numbers of testing tasks to the testing item; each identification number of the testing tasks corresponds to one of the testing task functions; and
an executing module capable of reading the testing task functions from the testing task function database according to the identification numbers of the testing tasks and starting the testing task functions to control the least one testing station to test the electronic devices.

2. The testing system of claim 1, wherein the executing module is further capable of exporting a report to show a testing result of the electronic device.

3. The testing system of claim 2, wherein the configuration module is further capable of setting formats of the report.

4. The testing system of claim 1, wherein the configuration module is further capable of modifying property of the at least one testing station.

5. The testing system of claim 4, wherein the property of the least one testing station comprises at least one of name and identification number.

6. The testing system of claim 1, wherein the configuration module is further capable of setting identification numbers of the at least one testing station.

7. The testing system of claim 1, wherein the configuration module is further capable of determining testing sequence of the at least one testing station.

8. A method for at least one testing station testing electronic devices, the method comprising:
setting a testing item and identification number of testing tasks to the testing item;
reading one or more testing task functions according the identification number of one or more testing tasks from a testing task function database; and
starting the one or more testing task functions to control the at least one testing station to test electronic devices.

9. The method of claim 8, further comprising: exporting a report to show a testing result of the electronic device after the electronic devices are tested.

10. The method of claim 9, further comprising: setting formats of the report before exporting the report.

11. The method of claim 8, further comprising: determining testing sequence of the at least one testing station before reading the testing task functions.

12. The method of claim 8, further comprising: determining testing sequence of the one or more testing tasks for testing the electronic device before reading the testing task functions.
